(19) United States
(12) Patent Application Publication
(10) Pub. No.: US 2011/0184759 A1
(43) Pub. Date: Jul. 28, 2011

(54) QUALITY IMPROVEMENT (QI) REVIEW SYSTEM AND METHOD

(75) Inventors: Harry P. Selker, Wellesley, MA (US); Denise Daudelin, Hanover, MA (US); Joni R. Beshansky, Wayland, MA (US); Manlik Kwong, Corvallis, OR (US)

(73) Assignee: Clinical Care Systems, Inc., Bedford, MA (US)

(21) Appl. No.: 12/974,580

(22) Filed: Dec. 21, 2010

Related U.S. Application Data
(60) Provisional application No. 61/289,116, filed on Dec. 22, 2009.

(51) Int. Cl. G06Q 50/00

(52) U.S. Cl. 705/3

(57) ABSTRACT

A computer-implemented clinical quality review method involving: for each of a plurality of medical problem types, storing a corresponding set of review criteria; receiving a plurality of electronic patient care records (ePCRs) from a medical service provider (MSP), each ePCR identifying a patient treated by the MSP and information about the medical care provided to that patient by the MSP, including: clinical problem type, clinical impressions, symptoms, and details about the evaluation of and treatment provided to that patient by the MSP; and for each ePCR: (i) determining whether the medical care meets the set of review criteria associated with the medical problem type identified in that ePCR; (ii) if the medical care passes the set of review criteria, approving the medical care provided to that patient and forwarding information about the medical care provided to that patient to a reporting system; and (iii) if the medical care does not pass the set of review criteria, generating a notification indicating that a manual review of the medical care provided to that patient is required.

This application claims the benefit of U.S. Provisional Application No. 61/289,116, filed Dec. 22, 2009, all of which is incorporated herein by reference.

### TECHNICAL FIELD

This invention generally relates to a system and method for performing quality improvement review of medical care.

### BACKGROUND OF THE INVENTION

Emergency Medical Services (EMS) provide an essential health care function in cities throughout the country; they provide out-of-hospital acute medical care. The EMS team typically represents the first line response to many medical problems that occur in the community. They are usually the first medical response to arrive at the scene to help victims of car accidents, heart attacks, falls at home, violent crimes, etc. Their goal is to provide on-the-scene treatment to those in need of urgent medical care and/or to transport the patient to the most appropriate, nearby medical care facility (e.g. hospital).

The usual sequence of events often starts with a call to the 911 emergency telephone service alerting them to an emergency. The 911 service gathers the appropriate information from the caller and then notifies one or more local EMS services. The notification identifies the nature of the problem, the location of the victim, and whatever additional relevant details the 911 service was able to obtain during the emergency call. In response, one or more EMS services dispatch an ambulance to the scene accompanied by a team of paramedics (also referred to as medical technicians or emergency medical technicians (EMTs)).

At the scene the paramedics assess and diagnose the medical problem, provide whatever health care they are qualified to administer and then transport the patient to an appropriate, local healthcare facility, e.g. hospital. As part of their responsibilities, the paramedics document the event through what is often referred to as a run report. They identify the medical condition, describe the diagnostic procedures they applied, and describe the medical treatments that were administered. The run report is important for many reasons. Most importantly, it communicates to the hospital medical information that might be important for their treatment efforts. But it also provides documentation which can later be used to perform a quality assessment of the EMS teams and to thereby improve the services that are delivered.

Our society has become very dependent on EMS services. The quality of care that is provided by such services depends heavily on decisions made by paramedics at the patient's side. Effectively and efficiently monitoring and evaluating the quality of the service that is provided is essential to making sure that the services that are provided meet or exceed the standards of care that are expected of them by the medical community. Currently, however, as part of existing quality assessment efforts, the run reports are manually reviewed long after the incident. And that review really only assesses counts (i.e., how many incidents of a particular type were handled) and does not effectively assess clinical performance. Moreover, today the feedback cycle for such a manual review can be anywhere from six months to a year. By the time the results of such a manual review are available, nobody remembers the particular EMS runs that were reviewed and the usefulness of the feedback in terms of improving the performance of the paramedics is basically lost.

There is substantial room for improvement in the monitoring and evaluation of the level of care that is provide by the EMS services.

### SUMMARY OF THE INVENTION

In general, in one aspect, the invention features a computer-implemented clinical quality review method involving: for each of a plurality of medical problem types, storing in electronic data storage a corresponding different set of review criteria; electronically receiving a plurality of electronic patient care records (ePCRs) from a medical service provider (MSP), wherein each ePCR record among the plurality of ePCRs identifies a patient treated by the MSP and information about the medical care provided to that patient by the MSP, that information including: clinical problem type, clinical impressions, symptoms, and details about the evaluation of and treatment provided to that patient by the MSP; and for each ePCR within the plurality of ePCRs: (i) electronically determining whether the medical care provided to the identified patient meets the set of review criteria associated with the medical problem type identified in that ePCR; (ii) if the medical care provided to the patient passes the set of review criteria, electronically approving the medical care provided to that patient and forwarding information about the medical care provided to that patient to a reporting system; and (iii) if the medical care provided to the patient does not pass the set of review criteria, electronically generating a notification indicating that a manual review of the medical care provided to that patient is required.

Other embodiments include one or more of the following features. The computer-implemented method may further involve: electronically providing a case review interface that enables a third party to manually review the medical care provided to any patient for whom an electronic notification was generated; and electronically receiving via the case review interface input representing the manual review of the medical care provided to that patient. The computer-implemented method may also include electronically forwarding information about the manually reviewed records to the reporting system. The computer implemented method may further involve: at the reporting system, electronically analyzing the received information; and generating a report summarizing a quality of care provided by the MSP. The information about the medical care provided to that patient by the MSP also includes operational criteria.

In general, in another aspect, the invention features a computer readable physical medium storing a program which when executed on a computer system causes the computer system to: for each of a plurality of medical problem types, storing in electronic data storage a corresponding different set of review criteria; electronically receive a plurality of electronic patient care records (ePCRs) from a medical service provider (MSP), wherein each ePCR record among the plurality of ePCRs identifies a patient treated by the MSP and information about the medical care provided to that patient by the MSP, that information including: clinical problem type, clinical impressions, symptoms, and details about the evaluation of and treatment provided to that patient by the MSP; and for each ePCR within the plurality of ePCRs: (i) electronically determine whether the medical care provided to the identified patient meets a set of review criteria associated with the medical problem type identified in that ePCR; (ii) if the medical care provided to the patient passes the set of review criteria, electronically approve the medical care provided to that patient and forwarding information about the medical care provided to that patient to a reporting system; and (iii) if the medical care provided to the patient does not pass the set of review criteria, electronically generate a notification indicating that a manual review of the medical care provided to that patient is required.

Various embodiments of the invention are capable of substantially reducing the number of run reports that have to be reviewed manually, significantly reduces the time required to manually review individual records from hours to minutes, and greatly reduces the feedback cycle from months to hours. The more timely feedback that can be provided by various described embodiments can aid is significantly improve the performance of the EMS services and especially the paramedics that are part of the EMS team.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a flow diagram of the operation of the Quality Improvement Review service.

FIG. 2 illustrates a portion of the clinical review criteria matrix.

FIG. 3 is a QI Review summary screen.

FIG. 4 is a view of the expanded detail screen that is accessible from the QI Review summary screen shown in FIG. 3.

FIG. 5 is a case review work-list screen.

FIGS. 6A-C are further portions of the case review screen.

FIGS. 7A-B are the incident screens that are accessible through the incidents tab on the case review screen.

FIG. 8 is the medical history screen that is accessible through the medical history tab on the case review screen.

FIG. 9 is the assessment screen that is accessible through the assessment tab on the case review screen.

FIG. 10 is the care and vitals screen that is accessible through the care/vitals tab on the case review screen.

FIG. 11 is the ECG review screen that is accessible through the ECG tab on the case review screen.

FIG. 12 is the screen for the “submit ePCR data” function that is among the case reviews functions that are accessible case review screen.

FIG. 13 is the screen for the “follow-up” function that is among the case reviews functions that are accessible case review screen.

FIGS. 14A-B show the clinical review change wizard screens.

FIGS. 15 A-E shows the report wizard screens.

FIG. 16 shows an example of a report generated using the report wizard function illustrated in FIGS. 15A-E.

FIG. 17 illustrates a block diagram of a computer system on which the QI Review Software can be run.

### DETAILED DESCRIPTION

In general, the described embodiment is a quality improvement (QI) review system for automatically evaluating the quality of the care that is provided by the EMS teams responding to medical emergencies. The responding EMS team documents care given to the patient using a commercially available onboard electronic patient care record system. After the patient is transported to the hospital (or other medical facility), the data from the run report is provided to the QI review system. After data has been entered for a batch of run reports, the QI review system determines for each run whether the care provided by the EMS team met the standard of care that applies to that particular patient's condition. In other words, it determines whether the EMS team was doing things right or wrong. For each event (corresponding to a single run report), the system applies a corresponding set of review criteria to determine whether the paramedics had met the quality of care as established internally by the EMS or by community standards. There is available to the system a large matrix of review criteria designed to cover all of the medical emergencies for which the EMS wished to conduct QI review. The particular set of criteria from among the matrix of criteria that is applied to a given run is determined by the clinical condition that was being treated.

The QI review system automatically identifies run reports for which there is evidence that the paramedics appear to have failed to meet the applicable standards and it flags those run reports for manual review by a qualified person on the EMS staff. During the manual review, one or more reviewers will either confirm that the provided care did fail to meet the standard of care, that it met the standard of care even though it did not pass the automatic review, or that a further review is necessary. In many cases, the manual review of the flagged reports will determine that the entered data for the run contained evidence that either the medical treatment was appropriate or that other details justified the divergence from applicable standards. In other swords, the manual review will pass a percentage of the flagged reports. Among the ones that do not pass, either the manual review will confirm that there was a failure to meet applicable standards or questions a present that require review by a more skilled medical professional, e.g. a certified doctor.

The system notifies the doctor of the files or run reports that need his or her review. Using a software interface into the data that is provided by the QI review system, the doctor reviews the data for certain flagged run reports and makes a decision about the standard of care that was applied. The system records his or her conclusions as part of the data for that run.

The QI review system also includes a reporting engine that enables the EMS (or a third party providing the QI review analysis) to generate various reports on the performance of the company, the performance of individual paramedics, trends in performance, and comparisons with other EMS services in the area. The system can generate reports that summarize the care given to the number of patients handled by the EMS service; it can examine and report on the performance of individual paramedics; and it can aggregate data and look at performance of the EMS service in various categories e.g. for different medical conditions.

The predefined matrix of review criteria makes it possible for the QI review system to automate the process for the services provided by the EMS. With a sufficiently robust group of review criteria encompassing all of the medical situations that are of importance to the EMS it becomes possible to do automatically what was previously only possible to do by a slow, cumbersome, and error-prone extensive manual review process.

The QI review system, in essence, functions like a filter on the data from the run reports by passing those run reports that meet relevant standards of care and flagging others for manual review. Thus, it serves to substantially reduce the number of files that need to go through a manual review.

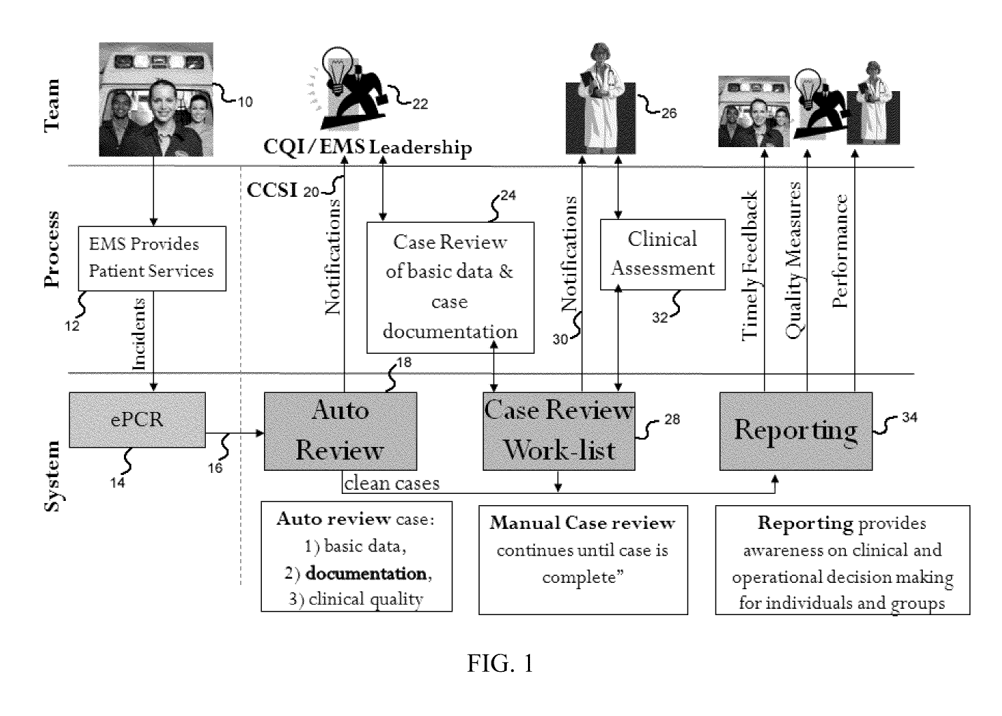

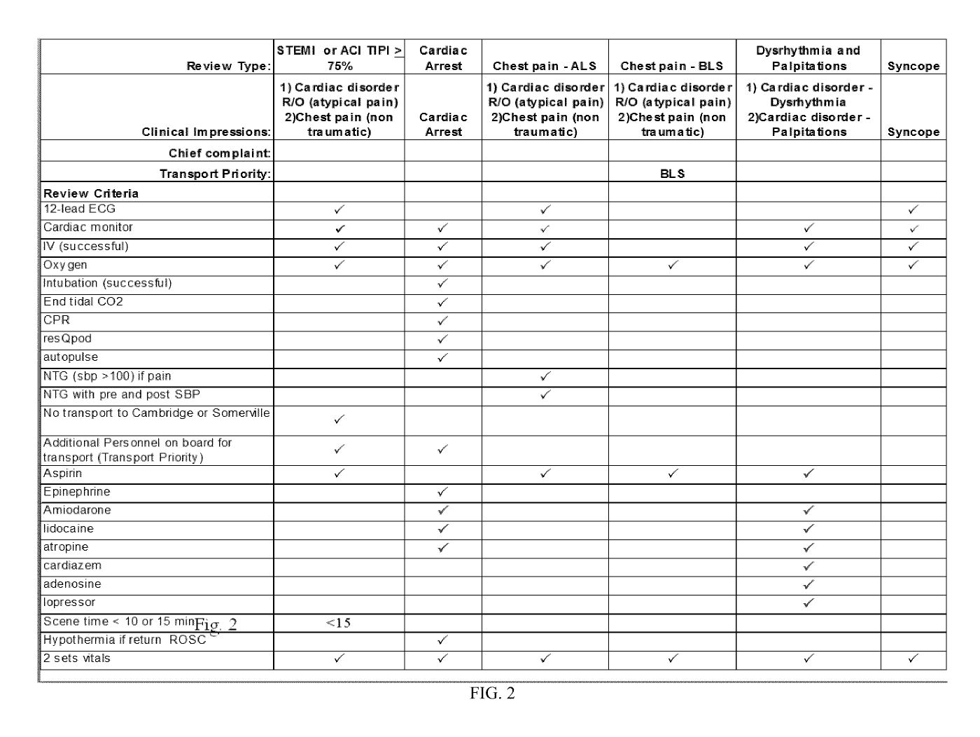

FIG. 1 shows a flow chart of a clinical quality process that is the subject of this application. In general, it is applied to EMS (Emergency Medical Services) which dispatch ambulances to deal with medical emergencies. The process typically begins with a 911 call that a medical emergency exists. This results in the dispatch of an ambulance with a team of paramedics (step 10). When the ambulance reaches the patient, the paramedics evaluate the condition of the patient, the medical problem that exists, and what on-site treatment is appropriate, and the transports the patient to a local hospital (step 12). The paramedics also administer whatever on-the-scene treatment is appropriate and transport the patient to the nearest hospital, if that is appropriate.

Typically the emergency vehicle includes a wide range of medical equipment including a computer system that hosts an electronic patient care record (ePCR) system. The paramedics enter data into that system to generate a record for the patient (step 14). The data that is entered typically includes identifying information about the patient, measured vital signs, symptoms, clinical impressions, and many details about the clinical review that was conducted and the treatment that was applied and operational information, such as details about the transport of the patient to the hospital. The record that is generated pursuant to procedures and requirements of the EMS documents the trip and becomes the EMS's patient care record for that trip or that run. After all of the required information is entered, the paramedic locks down the record to make it a permanent record to which no further changes will be permitted.

In the described embodiment, the quality improvement review is provided by a third party with which the EMS service has entered into a contract to receive such services (referred to herein as the QI Review service). On an hourly basis, the patient care record along with other records that were generated by that EMS team in that period, are electronically transferred to the computer system of a third party quality assessment agency (step 16). The frequency at which this transfer occurs is, of course, configurable by the EMS based on what seems most appropriate.

After a batch of records have been received, the QI review service then processes the received records with its computer system programmed with QI Review software. This involves analyzing each of the received patient care records to determine whether the paramedics met the applicable standard of care (step 18). The QI Review computer system has access to a matrix of clinical review criteria for a large range of different clinical conditions of the type that the paramedics are likely to treat when performing their job functions. Based on the information that was entered into the electronic patient care record by the paramedics, the software determines which set of clinical review criteria are to be applied to that incident or run report. Then, using those relevant criteria it automatically evaluates whether the paramedics met the applicable standard of care. All patient care records that pass this automatic review are designated as clean cases, meaning that the paramedic team performed as required, they correctly diagnosed the medical condition, and they administered the correct treatment.

The QI review computer system also identifies those records for which the paramedics failed to meet all of the review criteria for the particular medical condition. That is typically a much smaller subset of the patient care records. The QI review computer system flags those records as requiring a manual review and then notifies administrative staff at the EMS of this (step 20).

The QI review computer system also provides a graphical user interface to authorized people on the EMS staff to access the particular identified records that have been flagged as failing to meet the relevant review criteria and to review those run reports. This interface can be a browser interface that is accessed through the Internet or it can be provided via a direct connection to the QI review computer system through a private communications links. This enables the administration and designated reviewers to access basic data and supporting documentation including the locked down electronic patient care record that was provided by the paramedics as a result of the run.

Qualified staff people at the EMS (step 22) review the flagged records to confirm that the criteria were not met, to determine that the criteria were met as indicated by other information in the patient care record, or to determine based on a review of the supporting data that the criteria were not met but the care was appropriate (step 24). For a subset of those reports that are reviewed by the qualified staff of the EMS, it will typically be determined that further review will be required by a more qualified person, e.g. a physician reviewer (step 26) that is retained by the QI review service. The physician reviewer would most likely be a person trained or certified in areas that require more technical expertise such as interpreting ECGs and diagnosing cardiac conditions. The subset of records might automatically include any run reports for which it is considered to be necessary to have a more qualified person review the record (e.g. any run report that requires the interpretation of a patient ECGs that was recorded during the run).

The subset of reports is added to a case review work list (step 28) that is reported to or made accessible by the reviewing physician. The reviewing physician also is given the authority to select other run reports or records in the system for which he or she wants to conduct a further quality assurance review of run reports that have been cleared.

The system notifies the reviewing physician electronically (step 30), e.g. by sending an email. But because of the restrictions against distributing confidential patient information the notification will typically not contain patient information but it will simply be an alert telling the reviewing physician that records have been flagged for his or her review.

By moving part of the review process to the automated software and to initial administrative review of flagged records, this greatly reduces the burden on the reviewing physician. Since the physician only looks at the exceptions and a limited number of other records this reduces the magnitude of the task that confronts the reviewing physician. As an example, under the prior manual review procedures that operated without the aid of processes described herein, the task might consume 16 hours per week whereas with the help of the processes described herein that is reduced to 4 hours per month.

The reviewing physician, like the administrative reviewer earlier in the process, is also provided with electronic access to the system through an appropriate graphical user interface that is designed for performing that type of review that is to be conducted by a reviewing physician. In general, the physician performs a clinical assessment (step 32) of the flagged records much like the administrative people do. And the physician enters the results of the review into the system which stores them in its central database.

The software running of the QI Review computer system also implements a reporting package (step 34) that enables the QI Review Service and/or other persons to access the system to generate various reports about the performance of the EMS. Since in the described embodiment, the QI Review Service is provided by an independent third party, the service is able to generate both individual as well as comparative performance reports. For example, the system is able to give timely feedback regarding the performance of the paramedics on any individual run or aggregated over a group of runs over a period selected by the user. It can also produce a quality measure which compares the performance of the EMS to competitors. And it can produce reports showing how the EMS has performed over time, thus exposing trends in it performance.

We will now provide further details about the Quality Review application.

### The Matrix of Clinical Review Criteria

An important component in the QI review system is the matrix of clinical review criteria for the possible review types that might be handled by the EMS. A small subset of those criteria are illustrated in FIG. 2. A more complete matrix of clinical review criteria for a larger number of clinical conditions is presented in Appendix A, attached hereto. The matrix of clinical review criteria enable the QI Review Service to automate the review of the run reports for any of the medical conditions that might be handled by paramedics.

The top four fields are particularly important. They include (1) review type; (2) clinical impression; (3) chief complaint (symptoms); and (4) transport priority (critical or not critical). These four fields, also referred to as clinical condition identifiers, determine what set of review criteria are to be applied to the data from the run report. That is, the information entered into these fields determines what set of review criteria are to be used to automatically evaluate whether the treatment given met the applicable standard of care.

The data that populates these fields and that ultimately determines the particular set of review criteria that will be applied to the patient care record is extracted from the run reports that the paramedics fill in. The software on the EMS system typically will provide the user with a graphical user interface that includes drop-down menus that offer the user selections for entering data that is relevant to these top four fields as well as many other items for which the system expects data from the paramedic in order to produce a complete run report.

Based on the information that the paramedic enters into the EMS system and which is relevant to the top four fields, the Quality Review software selects the particular set of review criteria that are to be applied to the review.

The clinical review criteria vary depending on the clinical condition. Typically, they include such considerations as the tests that were performed, the treatments given, as well as operational considerations, such as, the timing of the treatments, the time on the scene, and the transport or response priority that was provided. In the described embodiment, there two transport priorities, namely, Advanced Life Support (ALS) and Basic Life Support (BLS). The one that is provided depends upon a determination made by the EMS dispatcher based on the initial information describing the nature of the medical problem for which the EMS services are required.

The range of review types is determined by the EMS service that wants its performance reviewed. However, since it would also be perceived as desirable to be able to compare ones service to those provided by competitors, it seems likely that there will be significant overlap in the clinical conditions that are reviewed and the review criteria that are applied to those conditions.

In the cases shown in FIG. 2, it may be only a subset of the four clinical condition identifiers that dictates or that are used to determine what the review criteria are. So, for example, if the paramedic has characterized the medical condition as cardiac arrest (i.e., stopped heart) then chief complaint is not really relevant and the review type dictates the set of review criteria. In the case of cardiac arrest, the review criteria are the ones that are checked. And the software will examine the rest of the run report to determine whether those other requirements are met. For example: was a cardiac monitor hooked up to the patient, was oxygen given, was intubation successfully performed, etc.

In addition, it should also be apparent that the operational criteria field is not relevant to all clinical categories. It is relevant, for example, in connection with medical conditions for which specialized treatment capabilities should be provided, e.g. seizures.

### The User Interface for QI Review System:

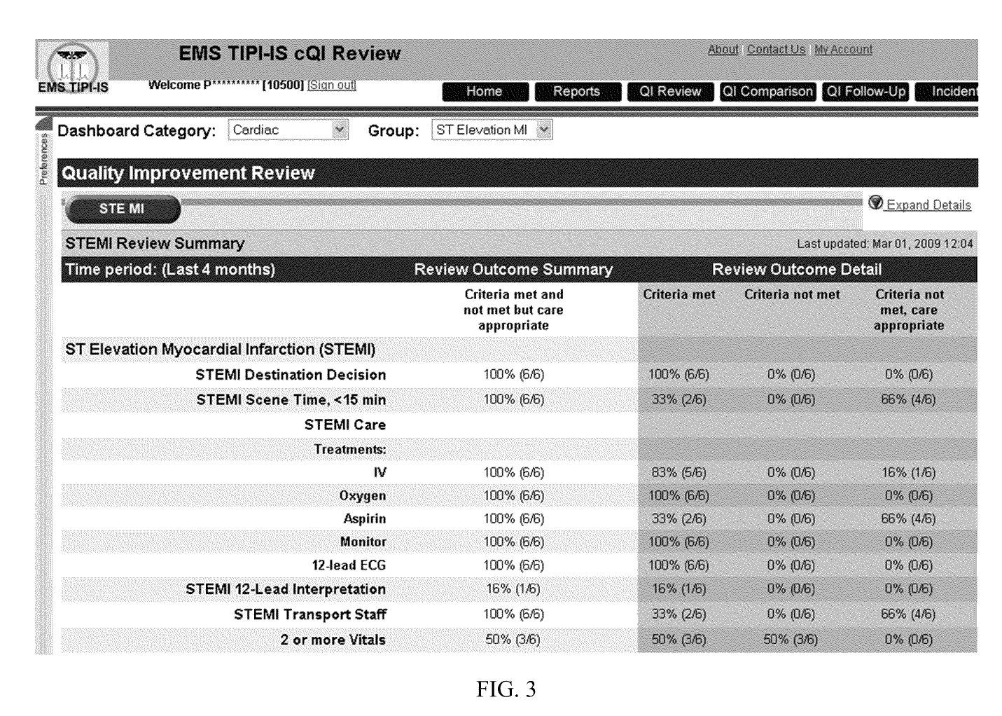

FIGS. 3-14 show the user interfaces through which the reviewers are able to conduct their manual reviews.

Initially, the user logs into the system and the level of access that is granted to the user reflects the authority that was defined for that user. For example, a paramedic might be given access to only view his or her performance data but not to view data for other paramedics or the company itself. On the other hand, the physician reviewer would be given access to all the records for which he must conduct a review and the ability to enter or change data in the system.

One category of screens available to this particular user upon logging into the system is the review summary screen illustrated by FIGS. 3. The user can select a category for which summaries are desired (e.g. cardiac) and in that category a group (e.g. STEMI, which stands for “ST segment elevation myocardial infarction,” which occurs when a coronary artery is completely blocked off by a blood clot). The user can also select the time period for which the summary review is desired (e.g. last 4 months).

The review summary is a scrollable screen of summary information about the selected medical condition. As shown in FIG. 3, the review summary window presents the relevant review criteria for that selected medical condition and two regions, one of which presents a review outcome summary and the other of which presents review outcome detail that underlies the review outcome summary. The review outcome summary indicates for each review criterion what percentage of the processed cases of this type either met the review criterion or though not meeting the particular criterion was care appropriate.

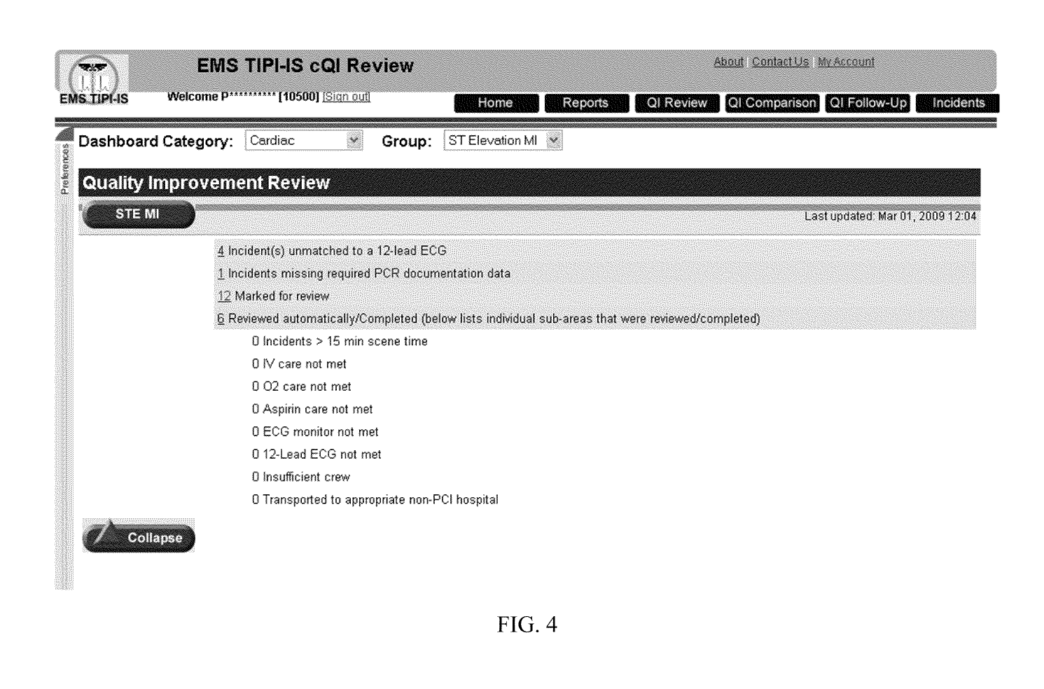

Upon selecting an expand details button in the screen shown in FIG. 3, the program displays the screen shown in FIG. 4. This presents a summary of what review needs to be conducted manually among the data presented in FIG. 3. In this case, it shows that 12 cases underlying the information displayed in on the summary data page have been marked for review, meaning that the program found exceptions or instances where the services provided by the paramedic as reported in his run report appeared not to have meet the standard of care.

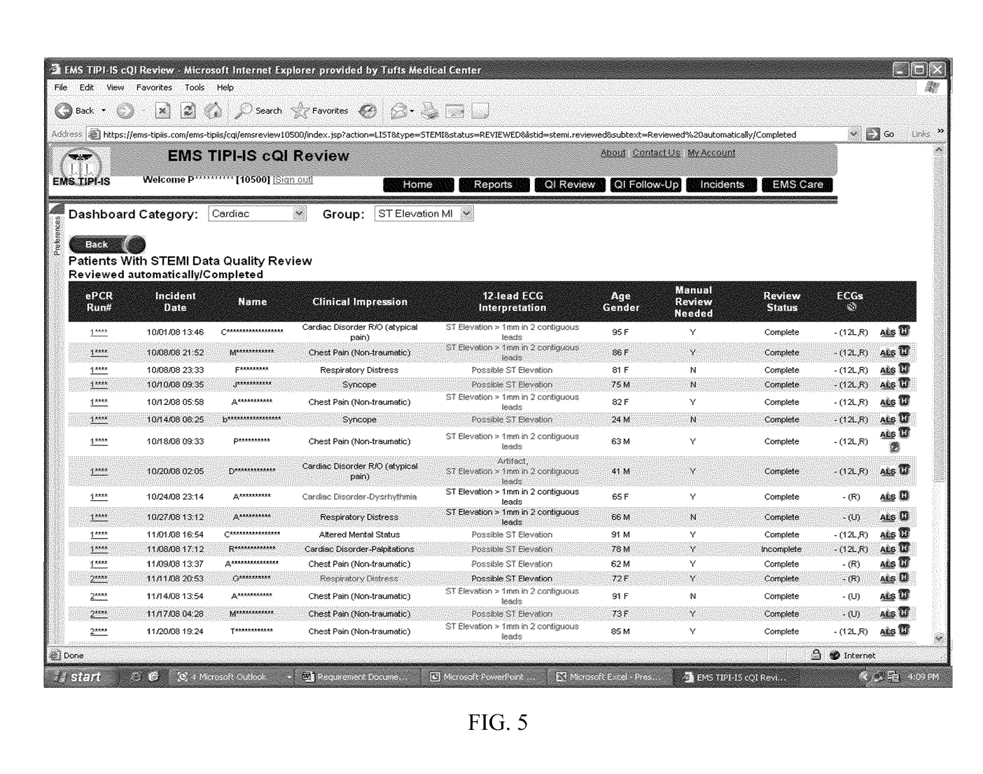

By selecting the 12 marked for review, the user causes the program to display the work list of patient care records that need to be manually reviewed (FIG. 5).

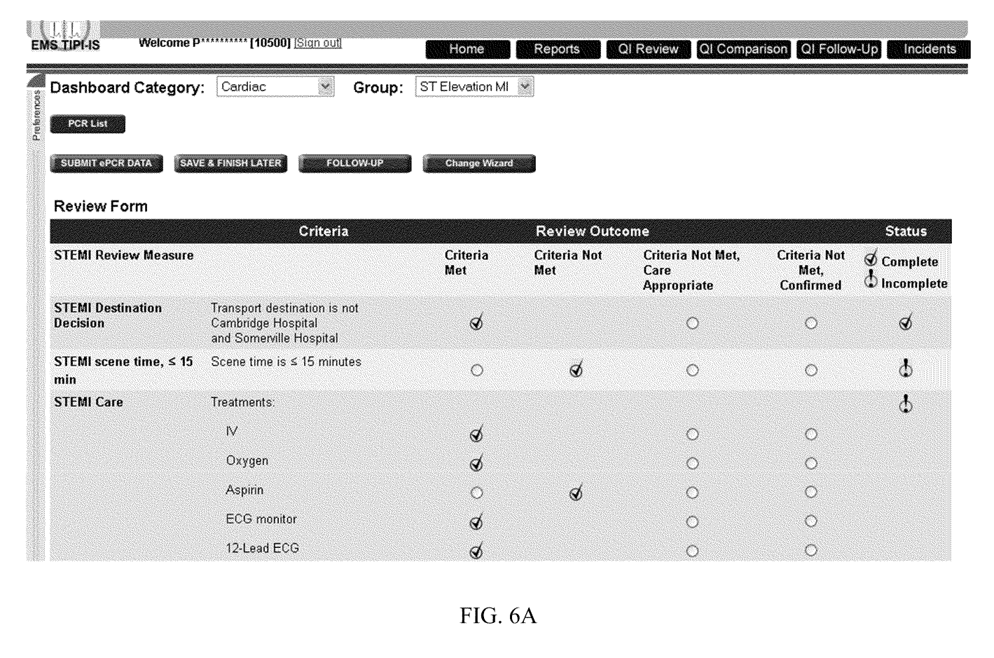

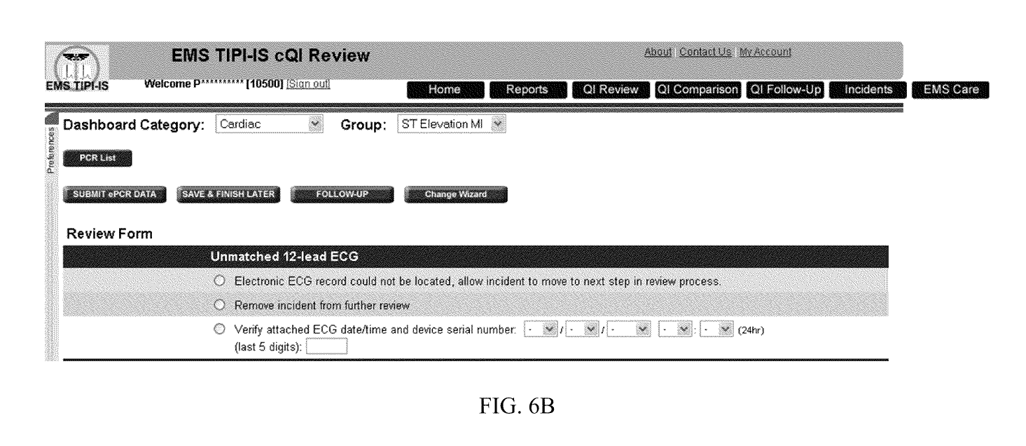

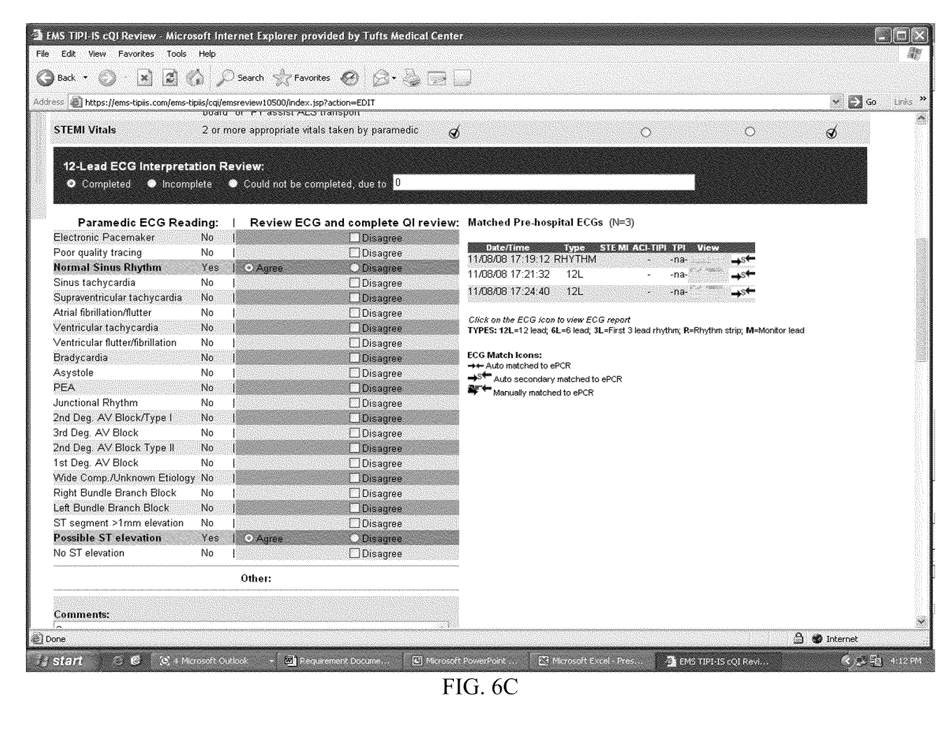

The user can look any one of the corresponding patient care records by simply clicking on that record in the screen shown in FIG. 5. The program then displays the information shown in FIG. 6A. One can see that the program has automatically reviewed the run report for that patient and this screen presents some of the results of that review. For each of the review criteria, the program determines whether the criterion was met or not met. If the criterion was met, the program puts a check in the “criteria met” column next to that criterion. If it is not met it puts a check in the “criteria not met” column. And then it summarizes that status of the review of that criteria by indicating in the last column that either its status is “complete” or “incomplete.” If it is incomplete, further review will be necessary by the reviewer.

There are two additional columns in this screen, namely, a “criteria not met, care appropriate” column and a “criteria not met, confirmed” column. These are the columns that will be checked by the reviewer showing that that the manual review has been completed and indicating the result of that manual review. In the case of the STEMI scene time review criterion, once a check is put in either of those two columns, the program changes the status for that review criterion to “complete.”

Even though this particular screen shows that the aspirin treatment was not met, a review of the other data associated with the run report may indicate that the patient had previously taken aspirin in which case the decision to not administer further aspirin would have been appropriate to avoid over medication. So, the person conducting the manual review would put a check in the “criteria not met, care appropriate” column.

Further down on this review screen, the program displays the ECG related information shown in FIG. 6B. In this example, there was an unmatched 12-lead ECG. The reviewer is given three options: to indicate that the ECG record would not be found elsewhere in the run report and allow the review process to proceed; to discontinue review; or the identify and attach the ECG record if it was located.

Still further down in this screen, as shown in FIG. 6C, the program presents an ECG interpretation review interface. This enables the reviewer to indicate whether he or she agrees or disagrees with the observations that were made by the paramedic about the ECG traces. This particular screen shows that three ECG reports were taken and each is accessible to the reviewer by clicking on the appropriate icon in the area entitled “Matched Pre-hospital ECGs.”

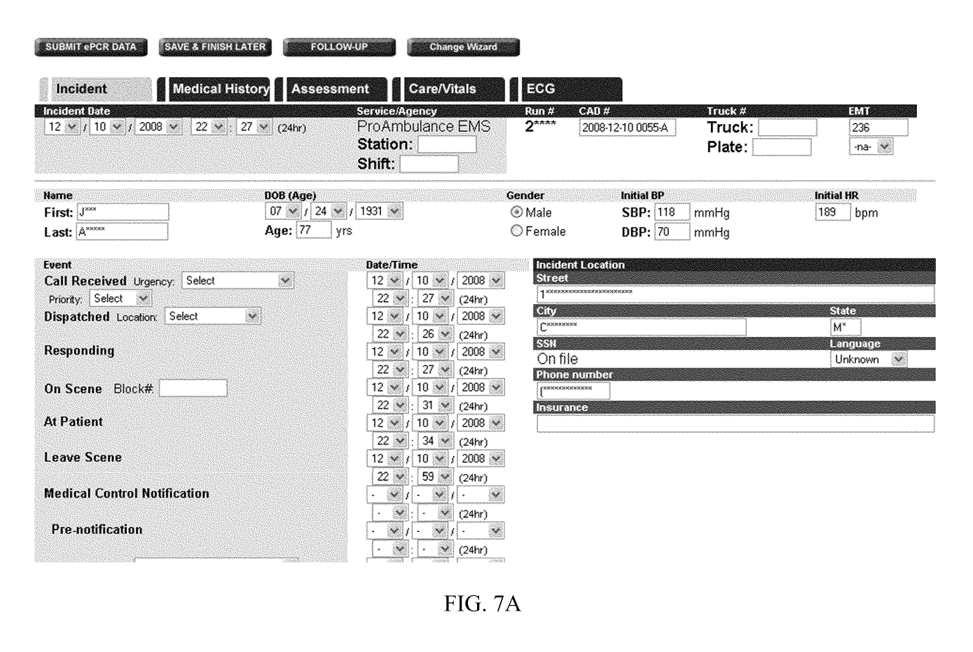

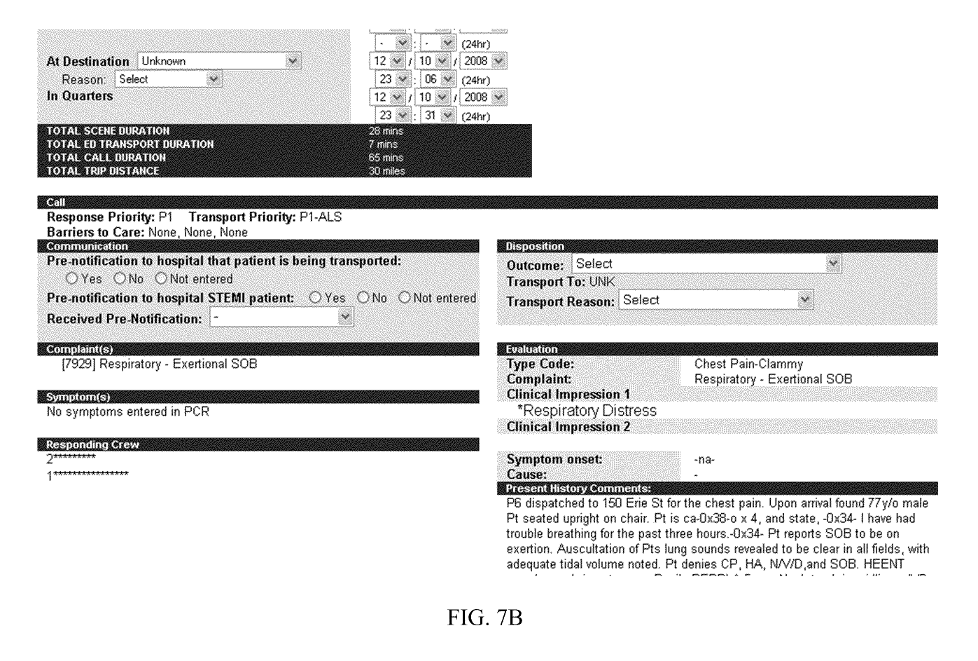

Below the ECG review screens, the program displays patient details (see FIG. 7A). There are five tabs presented to the reviewer enabling the reviewer to access different categories of information. There is an “Incident” tab which enables the reviewer to get access to details about the event to which the paramedics responded. In response to its being selected by the reviewer, the program displays the information shown in FIGS. 7A and 7B. FIG. 7A, which represents information found in the top portion of the window, presents details about the patient (e.g. name, date of birth, gender, etc.) and some details about the event (e.g. urgency of call, location, date and time, blood pressure readings, etc.). The information presented by the program in the lower portion of the incident screen is shown in FIG. 7B. It summarizes more details about the event and the patient's condition as observed and recorded by the paramedics, e.g. response priority, complaints, symptoms, evaluations such as clinical impressions, names of the responding crew, and present history commentary. The present history commentary captures the free text notes that were entered by the responding paramedics.

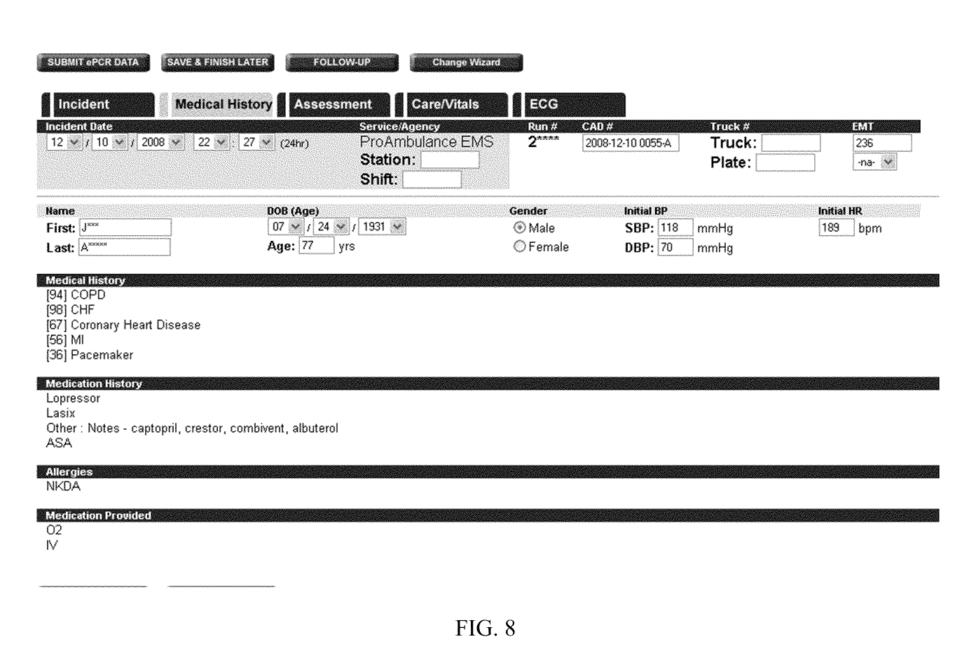

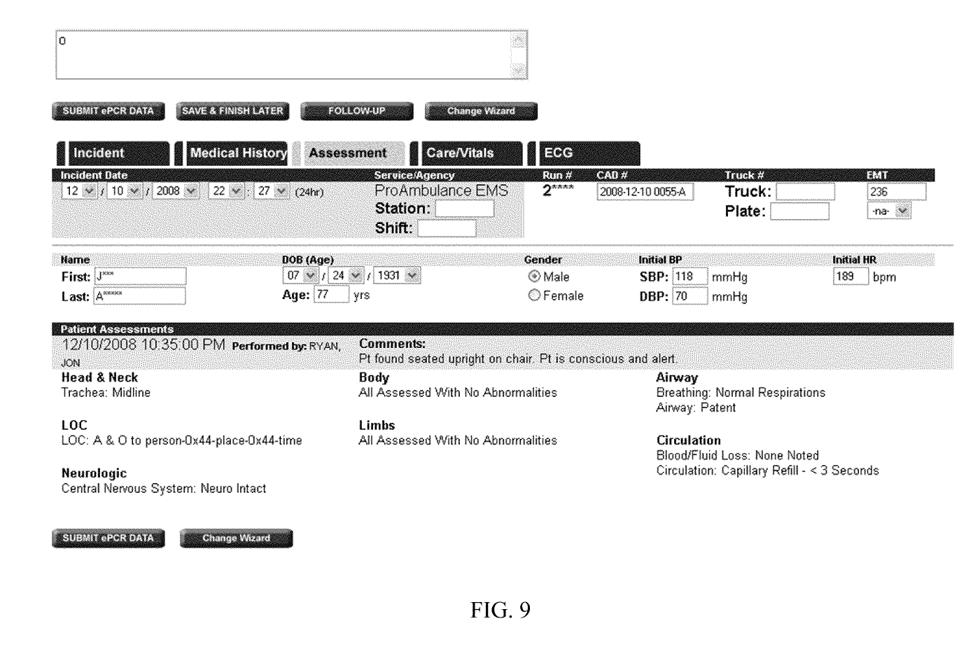

In response to the reviewer selecting the “Medical History” tab in FIG. 7A, the program displays the information of the type shown in FIG. 8. The displayed information includes, among other items, medical history, medication history, allergies, and medication provided.

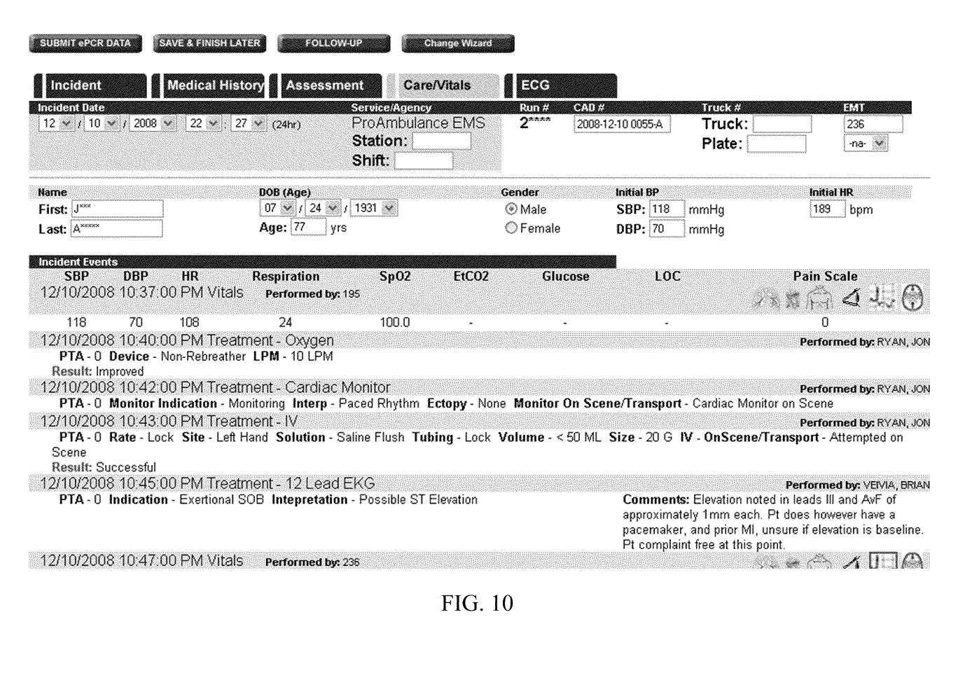

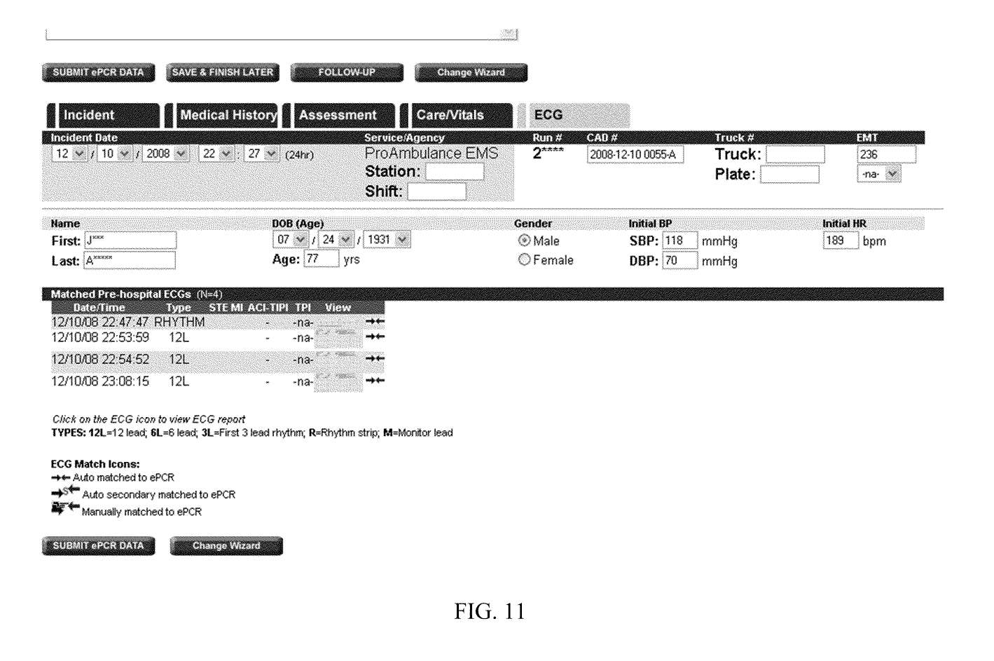

The “Assessment” tab brings up the information shown in FIG. 9. Again, the displayed information is extracted for the run report associated with this event and generally includes various assessments of the condition of the patient.

The “Care/Vitals” tab brings up the information shown in FIG. 10. This presents a list of what was done for the patient, when it was done, and what the results were.

Finally, the “ECG” tab invokes the display shown in FIG. 11 which gives the reviewer a list of the ECGs that were obtained during the event. The individual ECG charts can be accessed by simply clicking the view area associated with the particular ECG that the reviewer wants to see.

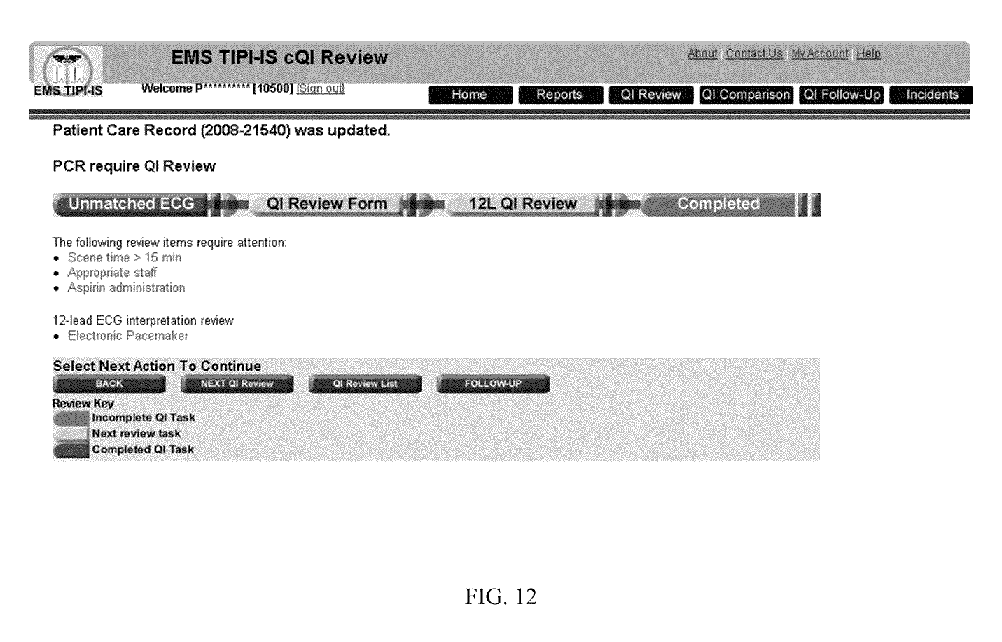

Note that on the review screen shown in FIG. 6A, there are a number of tabs that access other functionality of the program. When the initial reviewer is satisfied with his level of review, he can click on the “Submit ePCR” Data” button to submit whatever changes or additions he has made to the case. That will save the changes that he has made and bring up the screen shown in FIG. 12. This screen indicates what review has been completed and what further review, if any, needs to be conducted. In this case, the further review would be conducted by a physician who would be better qualified to assess the discrepancies or questions that were identified or left unresolved by the administrative review. This will then trigger the software program to notify the physician reviewer that there are patient care reports that require review. This screen also identifies that items that will require further review. For example, in this particular example, there were discrepancies relating to time on scene that exceeded standards, appropriate staff as defined by relevant protocols were not present, and there was an issue involving the administration of aspirin as required by the protocol. There is also an indication that the 12-lead ECG needs review because the patient was wearing an electronic pacemaker. In this case the administrative person was not authorized to address these discrepancies and was presumably required to pass the case record on to the physician for review by a specialist.

If the first reviewer is not able to complete his review in one session, he can click on the “Save & Finish Later” button and the program will store the record for later access. Since the review was not completed, no notifications will be triggered to the physician reviewer.

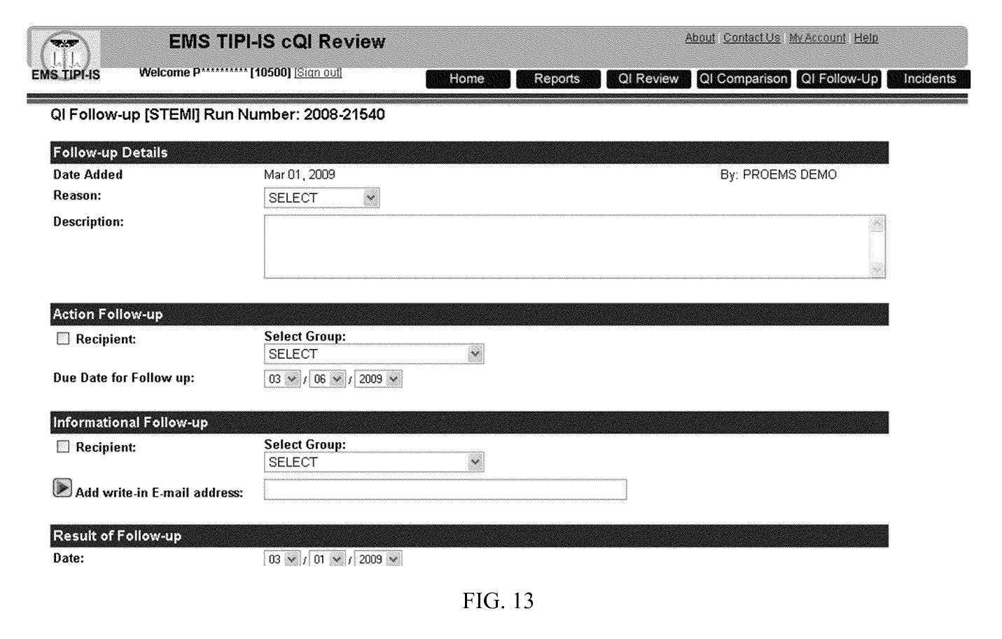

By clicking on the “Follow-Up” tab in the screen shown in FIG. 6A, the program enables the user to enter follow-up tasks for that particular patient care record. Activating this tab causes the program to display the screen shown in FIG. 13. In this particular embodiment, there are three types of follow up that are possible. The reviewer can add a note to the record which specifies the date that it was added, identifies by selecting from a drop down menu the reason for the follow up, and describes via a free text entry the description associated with the follow up.

The interface also presents the reviewer with the option of an action follow-up and an informational follow-up. For the action follow-up the user can specify a due date for the follow up and for both categories the user can select the group for which the follow-up is relevant. In the case of the informational follow-up the reviewer can also identify particular e-mail addresses to which the information will be sent.

An important application interface that is accessible to the reviewer through the screen shown in FIG. 6A is the Change Wizard which can be activated through the “Change Wizard” button. The Change Wizard interface enables the physician reviewer to correct errors that the paramedic made when diagnosing the patient's medical condition. If the paramedics select the wrong review type or other clinical condition indictors (e.g. clinical impression, chief complaint, and transport priority), then the wrong set of review criteria will be applied to the event and the automatic review will incorrectly evaluate the run. The physician reviewer can correct these errors through the change wizard interface.

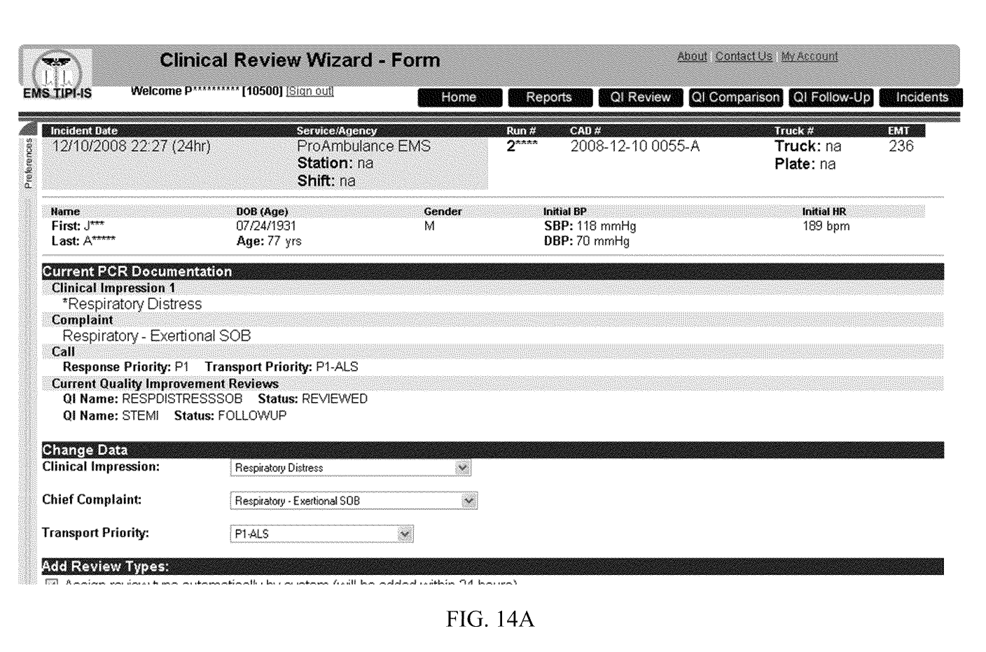

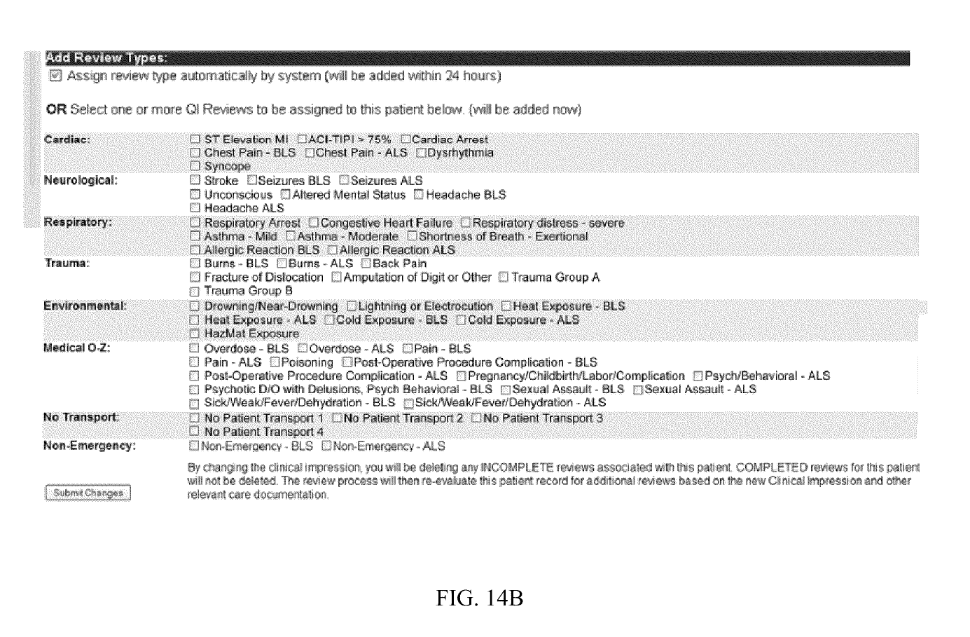

As shown in FIG. 14A, the change wizard interface presents the current patient care record documentation as entered by the paramedic. It shows the clinical impressions that were entered, the chief complaint, and the quality improvement review type. Below that is a “Change Data” region with data entry boxes that enable the reviewer to change any one or more of these indicators. The data entry boxes for clinical impression, chief complaint, and transport priority each includes a drop down menu which presents to the user the options that are available through the program. Below the Change Data section, there is a section entitled “Add Review Types,” shown in FIG. 14B.

By checking the box under the “Add Review Types” heading, the reviewer instruct the program to automatically assign a review type that is implied by the revised clinical condition indicators that were entered. Or the reviewer can select that appropriate review category by selecting the appropriate box among the available options presented in the lower portion of the displayed information

Once all of the appropriate changes have been entered by the reviewer, the changes can be submitted to the program by selecting the “Submit Changes” button in the screen shown in FIG. 14B. In response, the program deletes any incomplete reviews associated with that patient and re-evaluates the patient record for additional reviews based on the new clinical impressions and other relevant care documentation. In other words, the new clinical condition indictors are likely to result in a different set of review criteria being applied and the program evaluates the patient care that was administered based on those new review criteria.

Since the program is used to gather and evaluate data for many patients over a period of time and for many different EMS services or medical care provider agencies, it is programmed to analyze that data to provide very useful information and reports to the subscribers to the service. For example, the QI Review program is configured to generate the following types of reports:
a performance report for a particular type of patient event;
a performance report for the agency;
a report aggregating performance data for all patients that were treated by the EMS service within a selected period of time for a selected review type;
a performance comparison with another EMS service within a given geographical area;
a trend report for an EMS service showing whether quality of care is improving; and
a report comparing trend data for multiple EMS services in a given geographical region.
   Of course, it should be understood that these examples are meant to be illustrative and are not meant to be limiting.

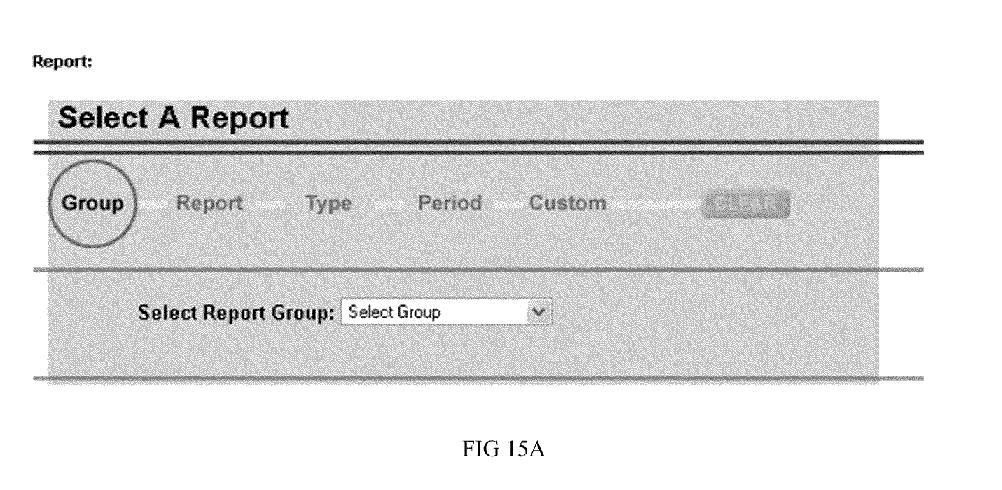

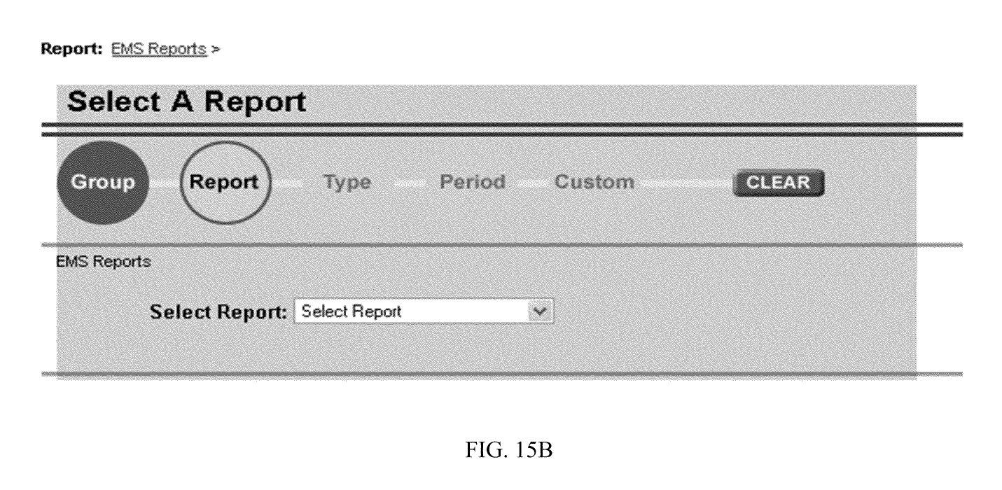

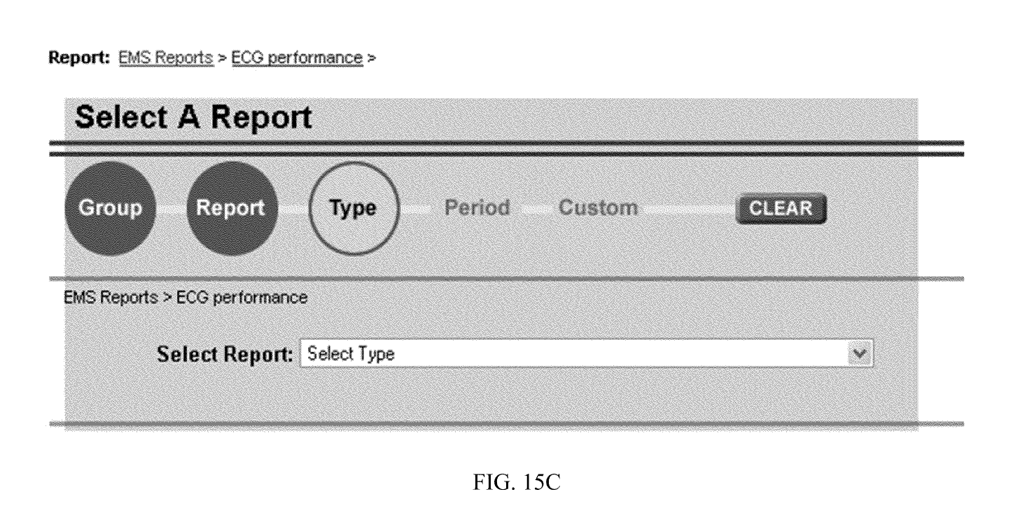

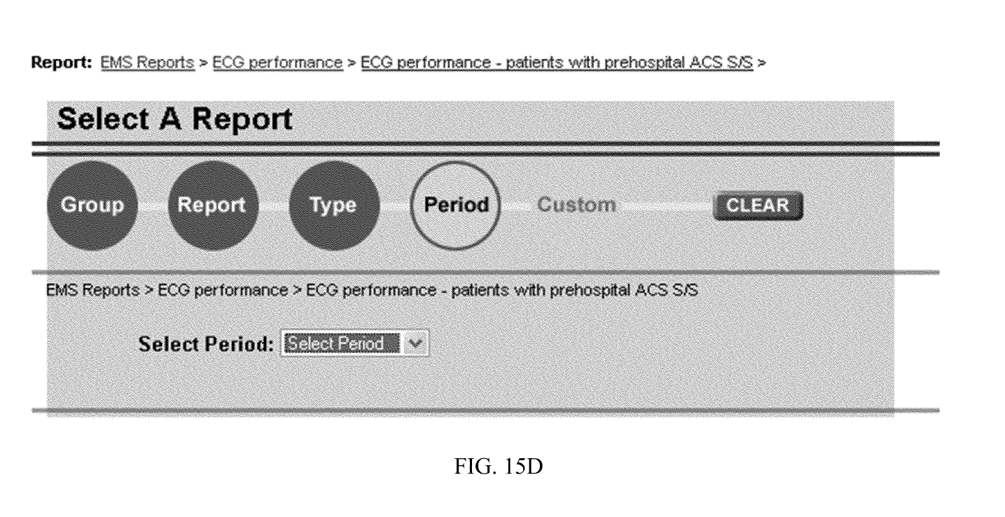

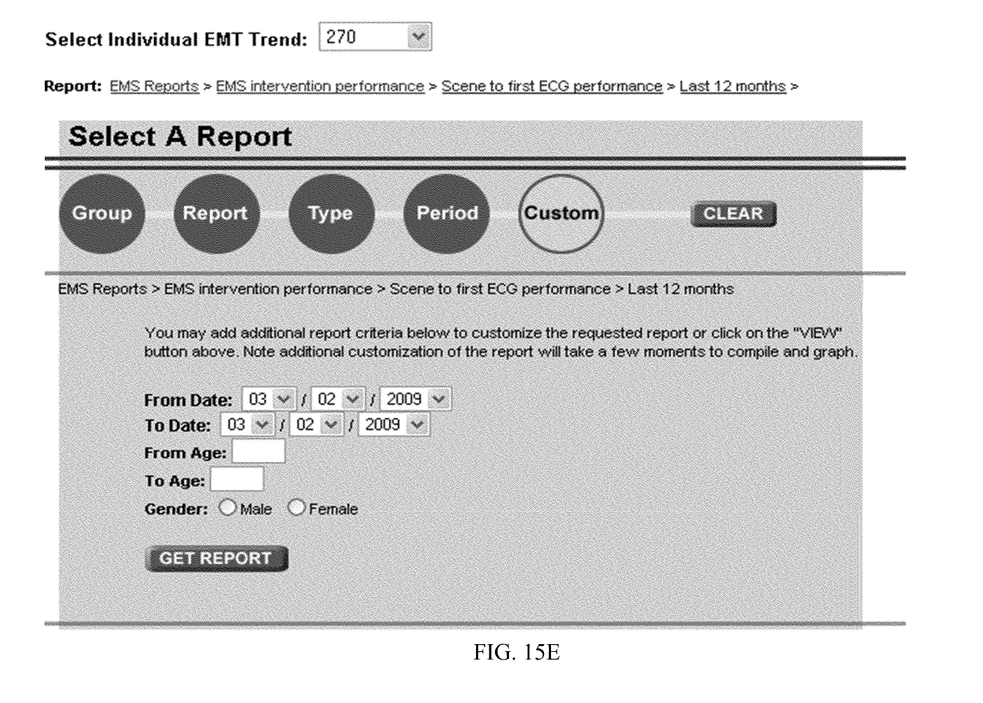

A report wizard interface for generating such reports from the collected data is provided by the QI Review software (see FIGS. 15A-E). This is a menu driven interface that enables authorized users to select what report is to be generated. As illustrated, the report wizard enables the user to select the group from which the report is to be generated (FIG. 15A). In this example, the selected group is “EMS Reports” (see FIG. 15BA). Next, the software invites the user to select a specific report (e.g. ECG performance) (see FIG. 15C). After selecting the specific report, the software invites the user to select the type of report (e.g. ECG performance for patients with pre-hospital ACS S/S) (see FIG. 15D). Next, the software invites the user to select the period of time which the report will cover (e.g. the last 12 months). Finally, the software gives the use the ability to customize certain aspects of the report, for example, by further defining the period to be covered by the report, by limiting the range of patient ages, and/or by selecting patient gender, just to name a few (FIG. 15E).

Once the report that the user desired is fully specified, the user selects the “Get Report” button on the user interface and the QI Review software responds by generating the requested report from the stored ePCR data.

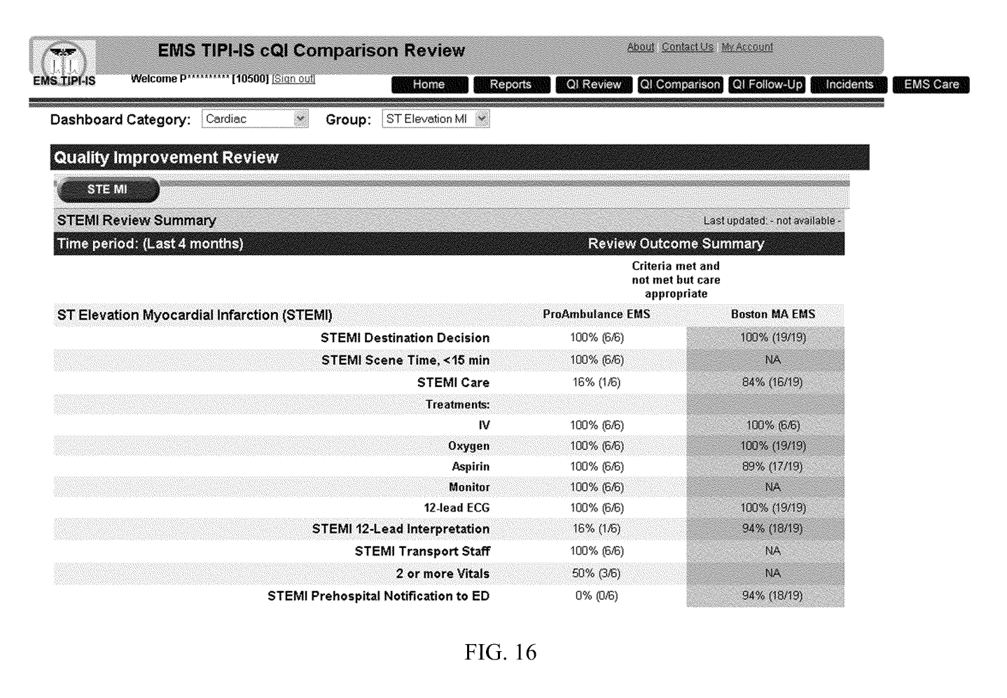

An example of a comparison report that the QI Review software could generate is shown in FIG. 16. This is an example of a comparison report that compares the performance of one selected EMS agency with an aggregate of the other EMS agencies in the same geographical area.

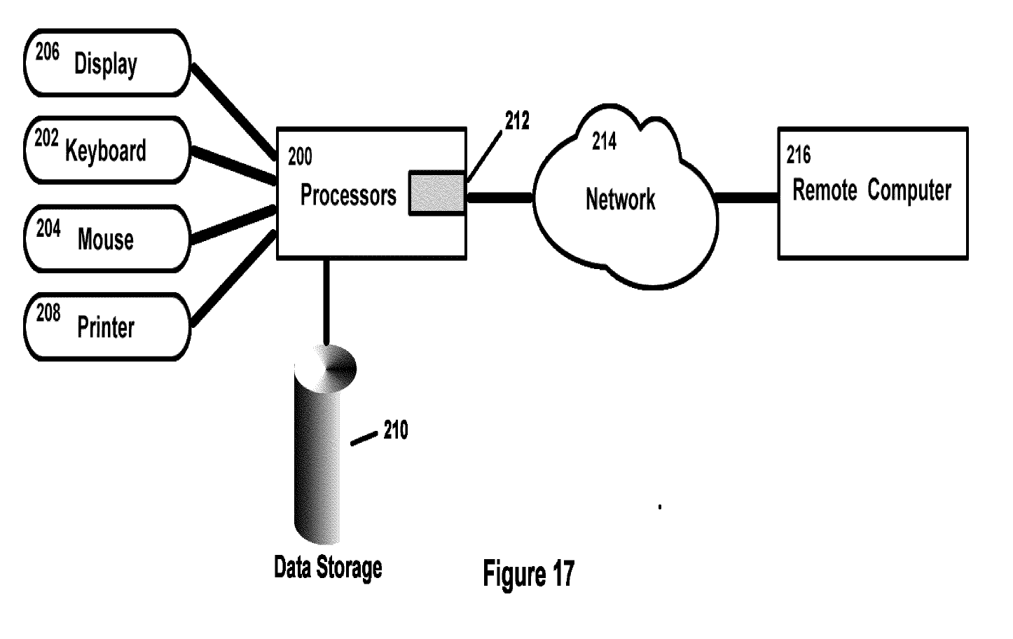

As illustrated in FIG. 17, the system on which the QI Review software is run can be a conventional computer system. Such a system might include, without limitation, one or more interconnected processors 200, various input devices (e.g. a keyboard 202 and a mouse 204), a display device 206 (possibly including a touch-sensitive screen to provide another way of inputting information), an output device 208 such as a printer for generating hard copies of the reports, and one or more digital data storage devices 210 for storing data such as the patient care record information that is downloaded from the EMS services. The QI Review software program (and its associated components and routines) all of which are executed by the computer system are stored on physical computer readable storage medium, e.g. disks, a flash drive, and/or physical memory (e.g. RAM). To enable remote access by users, there is a network interface 212 to a larger network 214, e.g. the Internet or a dedicated network. This enables a remote computer 216 to access the system, for example, to download run reports, electronic patient care records and other related data, to conduct a manual review of flagged run reports, or to cause reports to be generated as described above.

The systems and methods described herein are applicable not only to EMS services but they are also applicable to care provided by doctors at their offices or health care provided at offsite locations (e.g. locations away from a hospital). This more general category can be referred to as medical service providers (MSP).

Other embodiments are within the following claims.

1. A computer-implemented clinical quality review method comprising:
for each of a plurality of medical problem types, storing in electronic data storage a corresponding different set of review criteria;
electronically receiving a plurality of electronic patient care records (ePCRs) from a medical service provider (MSP), wherein each ePCR record among the plurality of ePCRs identifies a patient treated by the MSP and information about the medical care provided to that patient by the MSP, said information including: clinical problem type, clinical impressions, symptoms, and details about the evaluation of and treatment provided to that patient by the MSP; and
for each ePCR within the plurality of ePCRs,
i. electronically determining whether the medical care provided to the identified patient meets the set of review criteria associated with the medical problem type identified in that ePCR;
ii. if the medical care provided to the patient passes the set of review criteria, electronically approving the medical care provided to that patient and forwarding information about the medical care provided to that patient to a reporting system; and
iii. if the medical care provided to the patient does not pass the set of review criteria, electronically generating a notification indicating that a manual review of the medical care provided to that patient is required.

2. The computer-implemented method of claim 1, further comprising:
electronically providing a case review interface that enables a third party to manually review the medical care provided to any patient for whom an electronic notification was generated; and
electronically receiving via the case review interface input representing the manual review of the medical care provided to that patient.

3. The computer-implemented method of claim 2, further comprising:
electronically forwarding information about the manually reviewed records to the reporting system.

4. The computer implemented method of claim 3, further comprising:
at the reporting system, electronically analyzing the received information; and
generating a report summarizing a quality of care provided by the MSP.

5. The computer implemented method of claim 1, wherein the information about the medical care provided to that patient by the MSP also includes operational criteria.

6. A computer readable physical medium storing a program which when executed on a computer system causes the computer system to:
for each of a plurality of medical problem types, storing in electronic data storage a corresponding different set of review criteria;
electronically receive a plurality of electronic patient care records (ePCRs) from a medical service provider (MSP), wherein each ePCR record among the plurality of ePCRs identifies a patient treated by the MSP and information about the medical care provided to that patient by the MSP, said information including: clinical problem type, clinical impressions, symptoms, and details about the evaluation of and treatment provided to that patient by the MSP; and
for each ePCR within the plurality of ePCRs,
i. electronically determine whether the medical care provided to the identified patient meets a set of review criteria associated with the medical problem type identified in that ePCR;
ii. if the medical care provided to the patient passes the set of review criteria, electronically approve the medical care provided to that patient and forwarding information about the medical care provided to that patient to a reporting system; and
iii. if the medical care provided to the patient does not pass the set of review criteria, electronically generate a notification indicating that a manual review of the medical care provided to that patient is required.
